(19) United States
(12) Patent Application Publication
(10) Pub. No.: US 2026/0332795 A1
(43) Pub. Date: Oct. 22, 2026

(54) Media coding concept based on a variational autoencoder

(71) Applicant: Fraunhofer-Gesellschaft zur Förderung der angewandten Forschung e.V., München (DE)

(72) Inventors: Sophie PIENTKA, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/690,224

(22) Filed: May 28, 2026

Related U.S. Application Data
(63) Continuation of application No. PCT/EP2024/083808, filed on Nov. 27, 2024.

(30) Foreign Application Priority Data
Dec. 1, 2023 (EP) 23213789.3

(51) Int. Cl. H04N 19/42; H04N 19/124; H04N 19/13; H04N 19/137; H04N 19/172

(52) U.S. Cl. CPC H04N 19/42; H04N 19/124; H04N 19/13; H04N 19/137; H04N 19/172

(57) ABSTRACT

A media decoder for decoding media-related data concerning a media signal from a data stream having been encoded by a variational autoencoder is presented. The media decoder has an entropy decoder configured to decode quantized remainder latents of a current frame of the media signal from the data stream, a latent inferencer having a first neural network and configured to derive latents of the current frame based on the quantized remainder latents of the current frame and latents of a previous frame using the first neural network, and a media data inferencer having a second neural network and configured to derive from the latents of the current frame the media-related data concerning the current frame using the second neural network.

### CROSS-REFERENCE TO RELATED APPLICATIONS

This application is a continuation of copending International Application No. PCT/EP2024/083808, filed Nov. 27, 2024, which is incorporated herein by reference in its entirety, and additionally claims priority from European Application No. 23213789.3, filed Dec. 1, 2023, which is also incorporated herein by reference in its entirety.

### TECHNICAL FIELD

Embodiments according to the invention relate to apparatuses and methods for coding a data stream encoded by a variational autoencoder. Embodiments according to the invention relate to neural network based media coding.

### BACKGROUND OF THE INVENTION

Increasing amount of media is being transmitted, for example, via internet connections, local area networks, cloud computing resources and within company networks. Such media may be provided in various forms such as video signals, audio signals, images, 3D content, live streams and video games. For efficient storage and transmission of media signals, it is important to be able to code the media signals efficiently with a large degree of compression.

### SUMMARY OF THE INVENTION

According to an embodiment, a media decoder for decoding media-related data concerning a media signal from a data stream having been encoded by a variational autoencoder, may have: an entropy decoder configured to decode quantized remainder latents of a current frame of the media signal from the data stream, a latent inferencer having a first neural network and configured to derive latents of the current frame based on the quantized remainder latents of the current frame and latents of a previous frame using the first neural network, and a media data inferencer having a second neural network and configured to derive from the latents of the current frame the media-related data concerning the current frame using the second neural network.

According to another embodiment, a variational media autoencoder for encoding media-related data concerning a media signal into a data stream, may have: a media-to-latents encoder having a first neural network and configured to derive from a current frame of a media signal to be encoded interim latents of the current frame, a remainder inferencer having a second neural network and configured to derive remainder latents of the current frame based on the interim latents of the current frame and latents of a previous frame using the second neural network, and a latent quantizer configured to quantize the remainder latents to obtain quantized remainder latents of the current frame, a further latent inferencer having a third neural network and configured to derive the latents of the previous frame based on the quantized remainder latents of the previous frame and latents of an even more previous frame using the third neural network, and an entropy encoder configured to encode the quantized remainder latents of the current frame into the data stream.

According to another embodiment, a method for decoding media-related data concerning a media signal from a data stream having been encoded by a variational autoencoder, may have the steps of: decoding quantized remainder latents of a current frame of the media signal from the data stream, deriving latents of the current frame based on the quantized remainder latents of the current frame and latents of a previous frame using a first neural network, and deriving from the latents of the current frame the media-related data concerning the current frame using a second neural network.

According to another embodiment, a method for encoding media-related data concerning a media signal into a data stream, may have the steps of: deriving from a current frame of a media signal to be encoded interim latents of the current frame using a first neural network, deriving remainder latents of the current frame based on the interim latents of the current frame and latents of a previous frame using a second neural network, and quantizing the remainder latents to obtain quantized remainder latents of the current frame, deriving the latents of the previous frame based on the quantized remainder latents of the previous frame and latents of an even more previous frame using a third neural network, and encoding the quantized remainder latents of the current frame into the data stream.

Another embodiment may have a data stream generated using the above method for encoding according to the invention.

In accordance with an aspect of the present invention, a media decoder for decoding media-related data concerning a media signal from a data stream having been encoded by a variational autoencoder is provided. The media decoder comprises an entropy decoder configured to decode quantized remainder latents of a current frame of the media signal from the data stream, a latent inferencer comprising a first neural network and configured to derive latents of the current frame based on the quantized remainder latents of the current frame and latents of a previous frame using the first neural network, and a media data inferencer comprising a second neural network and configured to derive from the latents of the current frame the media-related data concerning the current frame using the second neural network.

In accordance with another aspect of the present invention, a variational media autoencoder for encoding media-related data concerning a media signal into a data stream is provided. The variational media autoencoder comprises a media-to-latents encoder comprising a first neural network and configured to derive from a current frame of a media signal to be encoded interim latents of the current frame, a remainder inferencer comprising a second neural network and configured to derive remainder latents of the current frame based on the interim latents of the current frame and latents of a previous frame using the second neural network, and a latent quantizer configured to quantize the remainder latents to obtain quantized remainder latents of the current frame, a further latent inferencer comprising a third neural network and configured to derive the latents of the previous frame based on the quantized remainder latents of the previous frame and latents of an even more previous frame using the third neural network, and an entropy encoder configured to encode the quantized remainder latents of the current frame into the data stream.

The latent inferencer allows deriving latents based on latents of a previous frame (and therefore information available at the decoder and encoder) as well as the quantized remainder latents that are transmitted in the data stream. Therefore, redundant information from previously coded frames can be used to derive information of the current form (e.g., in form of prediction or a rate of change), whereas the quantized remainder latents allow correcting and/or influencing the inference of the latent of the current frame in order to improve accuracy. Since both inputs are in a latent space, the transmitted quantized remainder latents can be transmitted and the derivation can occur in an energy dense domain. The inferencing of the latents in the latent space can be utilized to make us of more redundancies and therefore improve coding efficiency. The further latent inferencer of the variational media autoencoder allows deriving latents based on even more previous frames and therefore enables accessing or using more information that may remove redundancies.

Furthermore, the latent inference outputs a latent, which can be used by a media data inferencer, which allows combining the latent inferencer in already existing and/or trained media data inferencer. For example, the neural networks of the latent inferencer and the media data inferencer may be provided as separate networks, which can be easily combined, trained separately or even trained in combination. The neural networks can also be realized by simple convolutional neural networks (CNN), which can easily be added to existing architectures and can use straightforward training process. Since deriving the latents allows predicting media related information such as a motion field, an image (or its residual), or audio signal in latent space instead of the original signal space (e.g., based on samples of an image or audio signal). As a result, compression can be further improved.

A compromise between coding efficiency and coding flexibility may therefore be improved.

### BRIEF DESCRIPTION OF THE DRAWINGS

The drawings are not necessarily to scale, emphasis instead generally being placed upon illustrating the principles of the invention. In the following description, various embodiments of the invention are described with reference to the following drawings, in which:

FIG. 1 shows a schematic view of a media decoder for decoding media-related data concerning a media signal from a data 16 having been encoded by a variational autoencoder;

FIG. 2 shows a schematic view of a method for decoding media-related data concerning a media signal from a data stream having been encoded by a variational autoencoder;

FIG. 3 shows a schematic view of a variational media autoencoder for encoding media-related data concerning a media signal into a data stream;

FIG. 4 shows a schematic view of a method for encoding media-related data concerning a media signal into a data stream;

FIG. 5 shows a schematic view of a system comprising an encoder Enc* and a decoder Dec*; and

FIG. 6 shows a schematic view of a variational autoencoder and a decoder.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

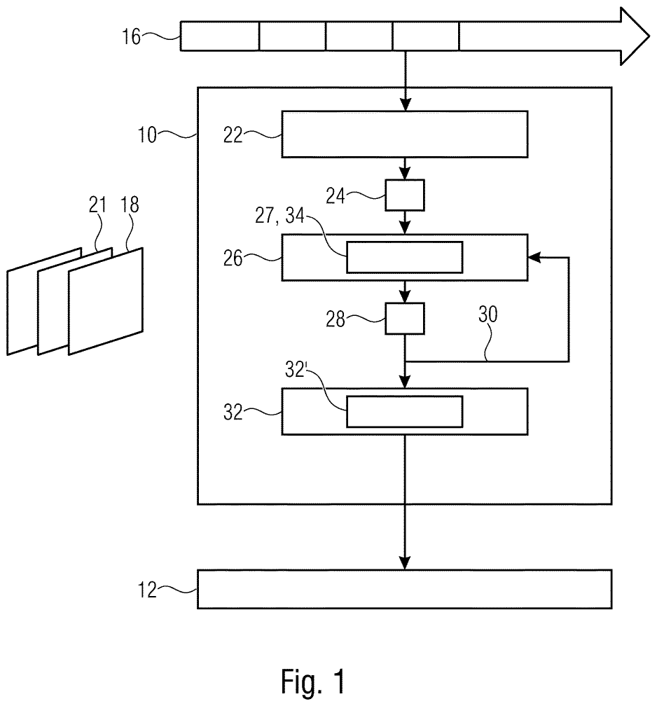

FIG. 1 shows a schematic view of a decoder 10 (or media decoder) for decoding media-related data 12 concerning a media signal from a data stream 16 having been encoded by a variational autoencoder (or variational media autoencoder) (not shown in FIG. 1).

The media decoder 10 comprises an entropy decoder 22 configured to decode quantized remainder latents 24 of a current frame 18 (e.g., picture, e.g., in the context of video coding) of the media signal from the data stream 16, a latent inferencer 26 comprising a first neural network 27 and configured to derive latents 28 of the current frame 18 based on the quantized remainder latents 24 of the current frame 18 and latents 30 of a previous frame using the first neural network 27, and a media data inferencer 32 comprising a second neural network 32′ and configured to derive from the latents 28 of the current frame 18 the media-related data 12 concerning the current frame 18 using the second neural network 32′.

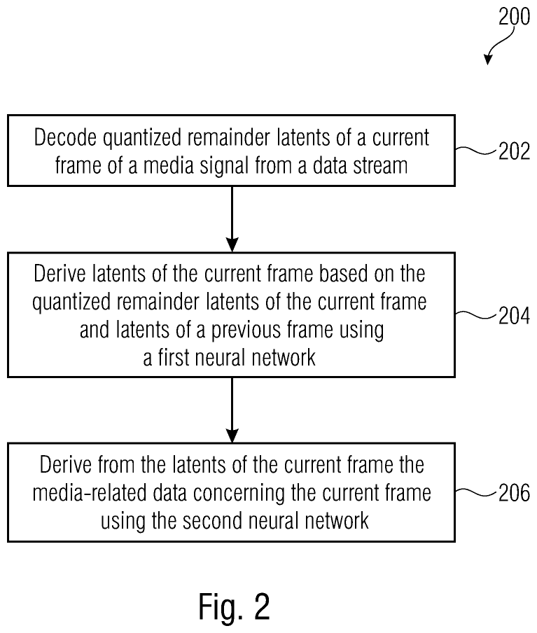

FIG. 2 shows a schematic view of a method 200 for decoding media-related data 12 concerning a media signal from a data stream 16 having been encoded by a variational autoencoder (VAE). The method 200 (and optionally with additional steps that correspond to any functionality of any media decoder 10 disclosed herein) may be performed by any media decoder 10 disclosed herein.

The method 200 comprises, in step 202, decoding quantized remainder latents 24 of a current frame 18 of the media signal from the data stream 16, deriving, in step 204, latents 28 of the current frame 18 based on the quantized remainder latents 24 of the current frame 18 and latents 30 of a previous frame 21 using the first neural network. The method 200 further comprises, in step 206, deriving from the latents 28 of the current frame the media-related data 12 concerning the current frame 18 using the second neural network 32′.

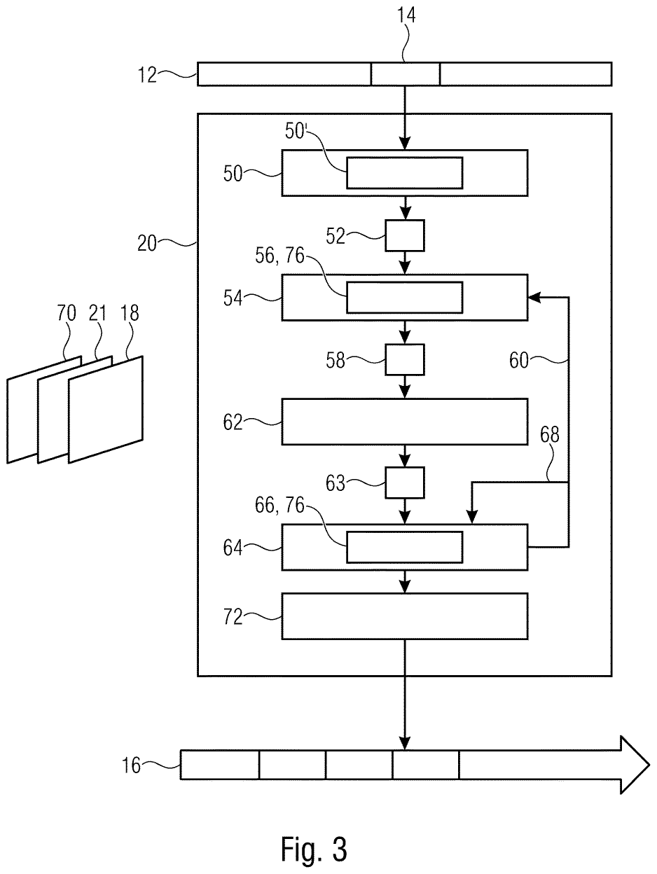

FIG. 3 shows a schematic view of a variational media autoencoder 20 for encoding media-related data 12 concerning a media signal into a data stream 16. The variational media autoencoder 20 comprises a media-to-latents encoder 50 comprising a first neural network 50′ and configured to derive from a current frame 18 of a media signal 14 to be encoded interim latents 52 of the current frame, a remainder inferencer 54 comprising a second neural network 56 and configured to derive remainder latents 58 of the current frame based on the interim latents 52 of the current frame and latents 60 of a previous frame 21 using the second neural network 56, and a latent quantizer 62 configured to quantize the remainder latents 58 to obtain quantized remainder latents 63 of the current frame, a further latent inferencer 64 comprising a third neural network 66 and configured to derive the latents 60 of the previous frame based on the quantized remainder latents 63 of the previous frame 21 and latents 68 of an even more previous frame 70 using the third neural network 66, and an entropy encoder 72 configured to encode the quantized remainder latents 63 of the current frame into the data stream 16.

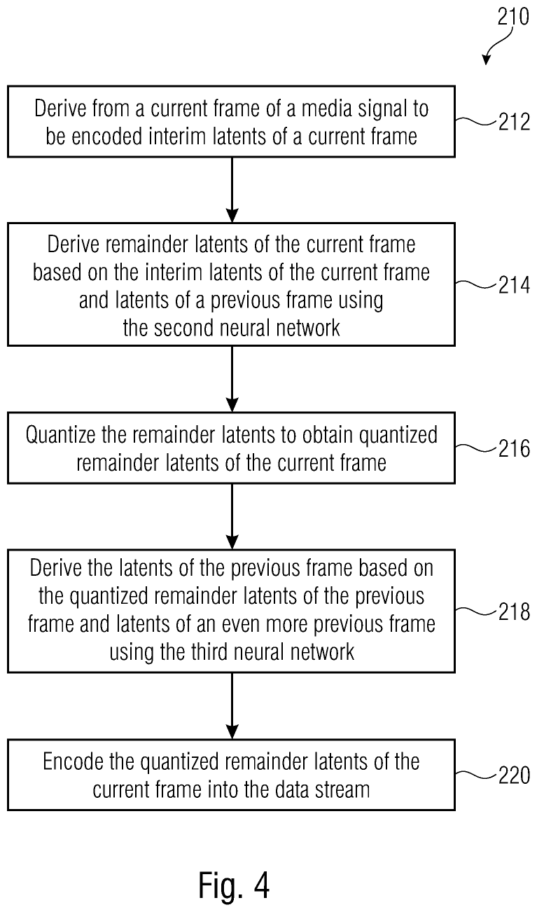

FIG. 4 shows a schematic view of a method 210 for encoding media-related data 12 concerning a media signal into a data stream 16. The method 210 (and optionally with additional steps that correspond to any functionality of any variational media autoencoder 20 disclosed herein) may be performed by any variational media autoencoder 20 disclosed herein.

The method 210 comprises, in step 212, deriving from a current frame 18 of a media signal 14 to be encoded interim latents 52 of the current frame, and deriving, in step 214, remainder latents 58 of the current frame 18 based on the interim latents 52 of the current frame 18 and latents 60 of a previous frame using the second neural network 56. The method 210 further comprises, in step 216 quantizing the remainder latents 58 to obtain quantized remainder latents 63 of the current frame and, in step 218, deriving the latents 60 of the previous frame based on the quantized remainder latents 63 of the previous frame and latents 68 of an even more previous frame 70 using the third neural network 66, and, in step 220, encoding the quantized remainder latents 63 of the current frame into the data stream 16.

Further may be provided a data stream generated by the method 210 (e.g., performed by the variational autoencoder 20). The data stream may be stored on a data storage or data storage medium (e.g., a computer-readable storage medium), wherein the data storage may, for example, be a non-transitory data storage or a non-volatile storage medium (e.g., a disk drive, USB-flash drive, a server, or a system of cloud data storage).

Any media decoder 10 disclosed herein (e.g., as shown in FIG. 1) may be configured to decode the media-related data 12 encoded by any variational media autoencoder 20 disclosed herein (e.g., as shown in FIG. 2).

The media decoder 10 and/or the variational media autoencoder 20 may comprise or may be part of a personal computer, a server, a cloud computing network, a mobile phone, a camera, a tablet, a note book, and an artificial intelligence assistance device.

The media signal may comprise one or more of a video signal (e.g., a pre-recorded video or a live stream), an audio signal (e.g., a video track, a music piece and/or a podcast session), a succession of images (e.g., a slide show), or video signals of multiple views. The media signal may comprise one or more of a depth map, an audio track, and subtitles. The medial signal may comprise a plurality of frames with a coding order, wherein the plurality of frames comprise a plurality of samples (e.g., pixels), which may be arranged in a rectangular shape. Each sample may be assigned a channel, e.g., a colour channel (e.g., three colour channels).

The data stream 16 comprises the media signal and may optionally comprise further data, e.g., related to one or more of data transmission, an error correction code, and data for different OSI model layers. The media-related data 12 concerning the media signal may comprises one or more of a representation of a change of the media signal between the current frame and the previous frame, a motion field between the current frame and the previous frame, a representation of the media signal at the current frame, e.g. a picture or an audio frame. The media-related data may comprise a representation of a change of features in a latent space (e.g., a residual for a prediction in the latent space). The media-related data may comprise a representation of a change of samples in a time or frequency-domain. The media-related data may comprise a representation of vectors for motion compensation (e.g., for predictive coding, e.g., motion compensation between the current frame 18 and the previous frame 21).

For example, the media-related data 12 may comprise a representation of a change of a video signal between the current and previous frame (e.g., a change of features or latents, e.g., a tensor with entries that define a change in the latent space). The change may relate to the change between a current and previous picture frame or audio frame (e.g., an audio frame having multiple samples, e.g., between 64 and 1024 samples). The media-related data 12 may comprise a motion field between a current and previous frame of a video signal, wherein the motion field or a change thereof may be represented in latent space. The media-related data 12 may comprise a representation of a picture or audio frame, wherein latents represent (or are mappable to) a picture (e.g., a texture or a depth map, or images of different views) or an audio frame.

Any neural network described herein may be realized by a separate network (e.g., wherein one or more of training, inference, and storage may be performed independently from other neural networks) or may be realized by a common neural network that realized two more neural networks (e.g., wherein for the two or more neural networks one or more of training, inference, and storage may be performed jointly). Each neural network may comprise one or more convolutional layers, for example, using a kernel (e.g., 3×3, 4×4, 5×5, or larger) that is scanned along input samples of a previous layer (e.g., with or without padding). Each neural network (e.g., one or more convolutional layers thereof) may comprise a non-linear activation function such as a ReLu function.

A latent may comprise or define a latent variable or latent entry, for example, of a latent tensor (e.g., a latent vector, one or more latent matrices, or a latent tensor with three or more dimensions). A latent may define a value for a feature (e.g., of a plurality of features). A feature may describe a property or characteristic, e.g., of a frame. A feature may be defined by one or more latents. The latents may be defined by a single tensor or by a plurality of tensors.

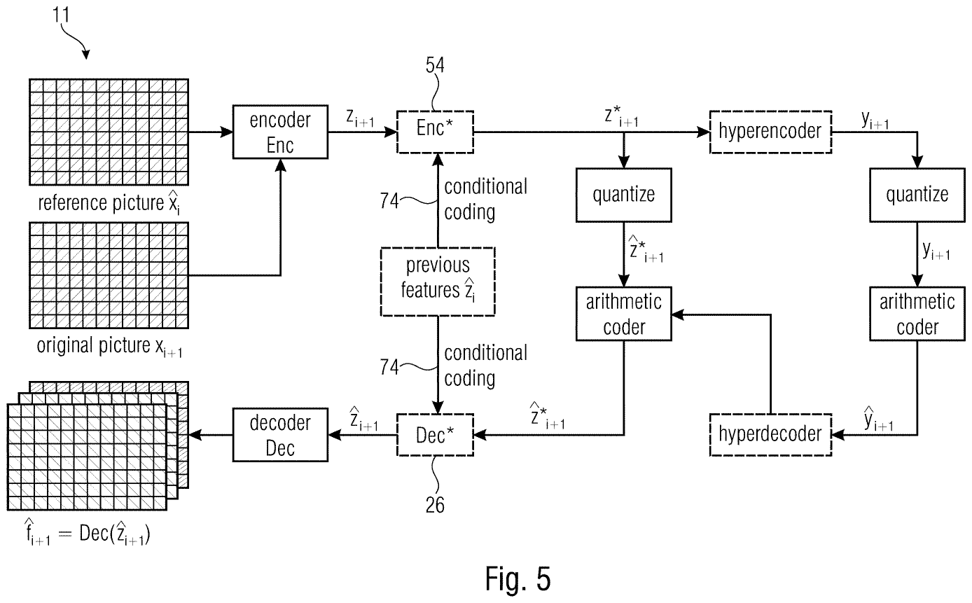

When a frame of the media is encoded to latents (e.g., by a media-to-latents encoder), the frame may be initially represented with multiple dimensions (e.g., three dimensions, one for height, one for width, and one for colour channel), wherein during processing through layers of a neural network (for encoding frames to latents), features and their values are determined in different dimensions. A latents may define a set of such features at an output of a neural network (or as an intermediate result). Commonly (but not necessarily), an output of a neural network (e.g., of a media-to-latents encoder) is defined by one or more latents in a latent space, which may have a smaller amount of dimensions (e.g., from a three dimensional tensor to a one dimensional vector) and/or values compared to the initial input frame. For example, latents may be defined as entries of a vector (i.e., a one-dimensional tensor) of 128 latents or entries. However, any other number of dimensions and amount of latents (or entries) may be possible. For example, features zᵢ₊₁ described further below with reference to FIG. 5 may be (at least partially) defined by latents and may span three dimensions (e.g., relating to a motion vector field).

The media decoder 10 may be one or more of a video's motion field decoder, a video decoder, and an audio decoder. The latents may therefore relate to (e.g., being mapped from, e.g., be representative of), a motion field, an image (or a plurality of images), or an audio track.

A frame may be, for example, an image or picture (e.g., in the context of video coding), a sample or a plurality of samples (e.g., form the same channel and/or from different channels) of an audio signal. Latents may relate to a picture (e.g., a picture being mapped into a latent space), but also to other media type that can be related to said picture, such as latents that are related (or represent) a motion field or a depth map. For example, the latents of the previous frame may relate to a picture (e.g., an image of the previous frame may be mapped onto said latents), whereas the latents 28 of the current frame 18 may relate to a motion vector field for the current frame 18.

Latents may be represented by a single tensor (e.g., a single tensor, matrix, or vector) or a set of tensors (e.g., a set of matrices and/or vectors). The set of tensors may be representative of a single media type (e.g., only video signals, vector motion field, or audio signals) or multiple media types (e.g., one or more of a video signal, audio signal, depth map, motion vector field, and a multiview video signal). The set of tensors may represent a higher dimensional tensor (e.g., the use of three matrices instead of a three dimensional tensor having one dimension for three colours).

For example, the latents of a frame may comprise a first subset of latents for an image and a second subset of latents for a movement field. A subset of latents for an image may comprise a plurality of latents (or entries) indicating different objects and/or a plurality of components (e.g., red, blue, green components or any other colour space or component plane). A subset of latents for a movement field may comprise a plurality of latents indicating movement of different objects and/or a movement of an entire screen.

A latent may define a value (e.g., between zero and one, e.g., between minus ten and plus ten or any other ranges, e.g., values defined by an integer, float, double, long double or any other data type) that define features (e.g., wherein a latent or entry indicates a weight, degree, or probability of said feature). The features may be features described in a human language (e.g., “person”, “ball”, “car”, cat”) and/or abstract features that are not related to human language (e.g., image pattern such as a density gradient of features, edge patterns, or periodic patterns). Since the latent space commonly has less dimensions and/or requires less values compared to a corresponding frame (e.g., fully or as an approximation), the latents may form a better compressed (or compressible) representation of a frame.

The latents may define features that (individually or in combination) indicate one or more of a motion of an entire screen (e.g., camera pan, camera zoom, camera rotation, camera tilt, dolly shot, tracking shot, handheld), a movement of an object (e.g., translational movement, rotational movement), and anatomical movement of a human or an animal (e.g., walking, talking, gesturing, interaction between two people). The latents may relate to more than one media type, e.g., features related to frame content and features related to a motion compensation.

The variational autoencoder 20 may comprise one or more (e.g., trained) neural networks and may be configured to map a media signal (e.g., an image, a motion field, an audio signal, a depth map) the latents. For example, the variational autoencoder 20 may be configured to map an input image (e.g., a tensor of values representative of or defined by samples values or pixel values of an image, e.g., in a time domain or frequency domain) onto the latents (e.g., of a latent tensor or latent vector, e.g., in a latent space). The media decoder 10 may be configured to map such latents back into an output image that may be identical or similar to the input image. Alternatively or additionally, the media decoder 10 and the variational autoencoder 20 may perform such a mapping (e.g., from input data to a latent space and from the latent space to an output data) for one or more other media type (e.g., a motion vector field, an audio signal, a depth map).

The media signal comprises the current frame 18 and the previous frame, wherein the previous frame has been coded (e.g., decoded or encoded) before (e.g., in coding order) the current frame 18. As a result, coding the current frame 18 can benefit from information obtained for the previous frame. The previous frame may immediately precede the current frame 18 or one or more frames may be coded between the previous frame and the current frame 18. The frames may be coded in a coding order, wherein the coding order can be identical to or different from a display order (e.g., a chronological order, for example, in which the frames are displayed within a video).

The entropy decoder 22 may be configured to perform coding (e.g., with lossless compression) using Huffman coding or arithmetic coding (e.g., context-adaptive binary arithmetic coding).

The remainder latents 24 may be quantized using a fixed quantization step size or a variable quantized step size. The remainder latents 24 may be quantized using dependent quantization (e.g., dependent on previously coded latents).

The first and second neural networks 27, 32′ may be separate networks (e.g., trained separately, e.g., having independent inputs and outputs) or may be part of a common network (e.g., trained in tandem, forming one or more layers within the same network).

A number of variables or entries of the quantized remainder latents may be the same or different (e.g., smaller or larger) than a number of latents of the previous frame (e.g., latents defined in a tensor, wherein both tensors have the same number of dimensions and/or latents). The number of latents of the previous frame may be the same or different than a number of latents of the current frame 18. For example, the current frame 18 may have one tensor, which is derivable from one tensor of the previous frame and one tensor of a quantized remainder latent. In a different example, one or more of a number of tensors, number of entries, and number of dimensions may be different.

The quantized remainder latents 24 may be assigned or assignable to the latents of the previous frame (e.g., for combination and/or comparison). For example, the quantized remainder latents 24 may be assigned to corresponding latents of the previous frame by one or more of a tensor structure, an indicator in data stream 16, a coding order (e.g., a pre-defined coding order and/or permutation information for the quantized remainder latents 24), and a tensor size (e.g., number of latents of a tensor).

The number of remainder latents 24 may be the same as a number of latents of a previous frame (e.g., vector length or matrix size). For example, a remainder latent 24 may have the same vector length as a corresponding latent of a previous frame, allowing for a latent-wise or entry-wise linear combination (e.g., addition and/or subtraction). The remainder latent 24 may have a smaller vector length (e.g., omission of zero-entries).

Deriving latents 28 (e.g., by latent inferencer 26 and/or the remainder inferencer 54) of the current frame 18 may comprise predicting the latents based on the quantized remainder latents 24 of the current frame and/or based on latents of the previous frame. The latents 28 of the current frame 18 may be predicted by predicting interim latents based on the latents of the previous frame and subsequently modifying (e.g., by an adder, e.g., linearly adding) of the interim latents based on the quantized remainder latents. However, the quantized remainder latents may at least partially influence the prediction itself. For example, at least a portion (or all) of the quantized remainder latents may be used as input at for the prediction, wherein, as an option a portion or all quantized remainder latents may subsequently be used to modify the prediction. In other words, the quantized remainder latents 24 may be used to modify a prediction result and/or influence the prediction itself.

For example, the first neural network of the latent inferencer 26 may have input neurons for receiving the quantized remainder latents and the latents of the previous frame as separate inputs, wherein the first neural network combines the two inputs (e.g., using one or more of weighted sums, linear function, non-linear function, e.g., a ReLu function) in order to obtain an output that is or forms a basis for the latents 24 of the current frame 18. Alternatively, at least some or all of the latents of the quantized remainder latents and the latents of the previous frame may be combined first (e.g., summed up and/or weighted) and subsequently input into the first neural network of the latent inferencer 26. The latents of the current frame 18 may therefore be inferred or predicted based on the two inputs.

Deep video coding has gained a lot of popularity in the last years. Usually, one may use the concept of inter prediction, for example, by transmitting features in latent space that represent a motion field and/or a residual. However, there may still be redundancies in such a setting that can be reduced by using additional previously coded information. A common approach may be to add an additional input at the encoder and decoder but that may come at the cost of changing the whole network architecture. Others keep the existing architecture but need to rely on additional modules in the underlying framework. In this disclosure, an easy-to-implement conditional feature coding module is presented, which may use the transmitted features and can be applied on top of any existing framework. It can be shows that this module can improve the performance by up to 9% compared to the underlying framework.

The following four chapters “4.1. Introduction”, “4.II. Basic motion compensation framework”, “4. III. Conditional and predictive coding of the motion information”, “4. IV. Training details”, “4.V. Experiments”, and “4.IV. Conclusions” describe exemplary embodiments of the invention disclosed herein. However, it is noted that any combination of features of said chapters may be combined with disclosure of any other chapter as well as any other disclosure herein.

### 4.I. Introduction

Video compression is still a topic of rising interest, as most of the global internet traffic is produced by video content. Especially low latency settings, such as video conferences, online gaming and live streaming continue to thrive. For the past decades, hybrid block-based video codes with handcrafted modules, such as H.264[1], H.265[2] and H.266[3] have been used.

Here, one of the underlying principles of inter coding is inter prediction which works as consecutive frames from one scene can be predicted with the estimated motion between frames. Then, instead of transmitting the whole image only, for example, the motion vectors are transmitted and are used to create a motion compensated prediction. As the motion may not be able to capture everything, as some parts may be occluded or have been lost during the transmission, the difference between the prediction and the original picture, also known as residual, may also be coded.

In a low-delay P setting, only the previous frames are used for the P frames (e.g., prediction frames). However, since the motion vectors from different frames themselves may be correlated, their inclusion in the prediction can improve the performance.

In hybrid block-based video coding, temporal motion vector prediction (TMVP) can be used as a candidate for different modes. For example in VVC, the motion vectors at a specific location in the collocated picture to the target reference picture may be added to candidate list for the merge mode and AMVP (advanced motion vector prediction) mode, see [4]. In some cases, the motion vector difference between the estimated motion vector and the motion vector predictor may also be signaled.

In the last years, an emerging trend are deep learned video compression frameworks which are usually based on variational autoencoders. They work by transforming the input information, an image or motion information, into a latent space by applying, for example, a convolutional neural network (CNN) which is also called encoder. The resulting features are then quantized and transmitted. Afterwards, a second CNN which is called decoder, is used to transform the quantized features back to the sample space. The first end-to-end trained video compression framework was DVC by Lu et al. [5] which employed different autoencoders for the tasks of motion compression and residual coding. In [6], Agustsson et al. introduced a scale space flow which uses an additional motion input to model an uncertainty factor.

A common approach to leverage additional information is to use sample-wise information. Ladune et al. [7] generalize the inter prediction by transmitting the motion field and an additional weighting matrix. Then instead of transmitting the residual, they use the weighted original picture and the weighted motion compensated prediction at the encoder and reuse the latter as additional input at the decoder.

In [8], Lin et at. use multiple reference frames and multiple motion fields. Instead of transmitting the current motion field, they use a network to predict it from the previous motion fields. Then, only the difference between the predicted motion field and the estimated motion field are transmitted.

Some frameworks, such as [9] or [10] use inter prediction but transmit the information with a single autoencoder. They use the information from previous frames by employing a generalized state, which is used as input for the encoder and updated for the current frame with the output from the decoder. Then, they use an additional module to generate the motion field and the residual from the updated state.

The listed approaches all use previously coded sample-wise information. This could lead to the loss of information compared to using the information in the latent space. Additionally,
such frameworks need to be trained from scratch, as their implementation changes the whole architecture. To circumvent this problem, another approach is to use the transmitted information in the latent space.

In [11], Hu et al. present a model where the whole process of inter coding is realised in the feature space. However, this leads to a large reference feature buffer which includes additional information that is not transmitted. They perform the motion estimation, compression and motion compensation in the feature space to get predicted features.

Lin et al. [12] use long short-term memory networks (LSTM) to divide the motion into intrinsic and compensatory parts. They use features that represent the partitioned motion field on the decoder side only.

Liu et al. [13] propose a generative adversarial network (GAN) based model which predicts the current feature in the latent space with an additional network from a set of previous features. Then, only the residual between the current features and the predicted features is transmitted and the prediction is added at the decoder as it only relies on already transmitted information. However, their loss function to train the feature prediction network includes an additional discriminator network although Liu et al. note that a similar PSNR could be achieved without the discriminator loss. While such GAN based frameworks have gained increased interest in video compression there are still many deep video compression frameworks with different approaches. Additionally, their quantization of the feature residual uses an iterative scheme.

In this disclosure is presented a generalized framework which works in the latent space by using the previously coded features and an additional encoder and decoder. Moreover, such a module can be easily implemented in existing deep video compression frameworks. Further below, is also shown a modification to said module which may restrict it by using a single additional network instead of two additional networks. This modification may be similar to the model in [13].

This chapter is structured as follows. First, the baseline architecture is explained in Section 4.II. In Section 4.III, the conditional feature coding module is described and it is explained how it can be modified to use one network instead of two. Then, is described describe the training details in Section 4.IV. Afterwards, the experimental results are presented for both versions in Section 4.V and the chapter concludes with Section 4.VI.

### 4.II. Basic Motion Compensation Framework

Let x₀, x₁, . . . , xₙ, xᵢ∈ [symbol] ^{W×H} denote a sequence (e.g., a total number i of frames with a width W and a height H, for example measured in samples or pixels) of consecutive luma-only frames that are to be transmitted in a low latency setting. However, any other sample format (e.g., luma and chroma, chroma-only, or depth map samples) and any other setting may be used instead. An I frame x₀ (e.g., intra frame) is coded with an appropriate codec, in our exemplary case VTM-14.0 [14] in All-Intra setting. The I frame x₀ may be coded without dependencies to other frames.

As a baseline framework, the architecture from may be used. Let x; indicate a coded reference picture (e.g., a previous frame, which may or may not be immediately preceding) and an original picture xᵢ₊₁ (e.g., a current frame to be coded) will be transmitted with inter prediction. The frames or pictures may be in represented in samples or pixels (e.g., in a spatial domain or frequency domain). Therefore, for example, a modified diamond search (or any other search method) may be used to find a block-based motion estimation with block size n×n (e.g., a rectangular or square block, e.g., with n smaller than width W and height T, e.g., with n being a power of two, e.g., 2, 4, 8, 16, 32, 64, or larger) between \hat{x}ᵢ and xᵢ₊₁ (e.g., in order to obtain a motion vectors or a motion vector field comprising the motion vectors, e.g., wherein motion vectors indicate a translation or relocation of a n×n block of the reference picture to predict or estimate an n×n block of the original picture). Afterwards, resulting motion vectors

$${f}_{i + 1}^{n \times n}$$

(e.g., with one or more vectors in units of pixels and/or sub-pixels, e.g., with one motion vector for each n×n block of the current frame, e.g., wherein the motion vectors and/or a motion field defined thereby may be part of media-related data) may be used with \hat{x}ᵢ and xᵢ₊₁ as input for an encoder Enc′ to create features

$${z}_{i + 1}^{n \times n}$$

(e.g., defined by latents, e.g., in form of a three dimensional tensor or any other number of dimensions) in a latent space as

$${z}_{i + 1}^{n \times n} = {Enc}^{′} ( {f}_{i + 1}^{n \times n} , {\hat{x}}_{i} , {x}_{i + 1} )$$

These features may be created for 4 different block sizes (or any other number of block sizes such as one, two, three, or more), ranging from 8×8 to 64×64 (or any other sizes) and then concatenated. For example, a main tensor may be formed by combining four tensors obtained for n=8, 16, 32, and 64 (e.g., by one or more of increasing a number of entries, adding further dimensions, and providing additional tensors). However, only one block size, or any other number of block sizes or sizes of blocks may be used instead.

TABLE I
Network architecture for the motion compensation framework from
[15]. Each row describes a convolutional layer of the network
where the first number implies the output channel, the second
and third number indicate the size of the used kernel and the
arrows show whether an up- (↑) or downsampling (↓) with
factor s was used. ReLu denotes the use of a Relu activation function.

| Encoder | Encoder | Decoder | Hyper- | Hyper- |
|---|---|---|---|---|
| Enc′ | Enc″ | Dec | encoder | decoder |
| 128 × 5 × 5, | 256 × 3 × 3, | 128 × 5 × 5, | 128 × 3 × 3, | 128 × 5 × 5, |
| 2 ↓ | 1 ↓ | 2 ↑ | 1 ↓ | 2 ↑ |
| ReLu | ReLu | ReLu | ReLu | ReLu |
| 128 × 5 × 5, | 128 × 3 × 3, | 128 × 5 × 5, | 128 × 5 × 5, | 192 × 5 × 5, |
| 2 ↓ | 1 ↓ | 2 ↑ | 2 ↓ | 2 ↑ |
| ReLu | | ReLu | ReLu | ReLu |
| 128 × 5 × 5, | | 128 × 5 × 5, | 128 × 5 × 5, | 256 × 3 × 3, |
| 2 ↓ | | 2 ↑ | 2 ↓ | 1 ↑ |
| ReLu | | ReLu | | |
| 128 × 5 × 5, | | 3 × 5 × 5, | | |
| 2 ↓ | | 2 ↑ | | |

Thereafter, an additional encoder Enc″ may be applied which results in the features zᵢ₊₁ (e.g., unquantized remainer latents) as

$${z}_{i + 1} = {Enc}^{″} ( {z}_{i + 1}^{8 \times 8} , {z}_{i + 1}^{16 \times 16} , {z}_{i + 1}^{32 \times 32} , {z}_{i + 1}^{64 \times 64} )$$

Both

$${z}_{i + 1}^{n \times n}$$

and zᵢ₊₁ have, for example, the dimensions

$$\frac{W}{16} \times \frac{H}{16} \times c$$

(or any other number of dimensions and/or at any other size, e.g., H/32×W/32×c, e.g., wherein for example c may be related to a channel number, e.g., c=3). For example,

$${z}_{i + 1}^{n \times n}$$

and zᵢ₊₁ may be defined by a three-dimensional tensor or by three two-dimensional tensors (e.g., matrix), wherein the three two-dimensional tensors are provided for each of three colour channels (e.g., blue, green, red).

Throughout the following text, Enc will refer to the application of Enc′ for 4 different block sizes and the subsequent concatenation of the features and application of Enc″. A concatenation may be omitted, for example, in the case of the use of only one block size n×n.

Note, that the motion field may use the scale space flow as in [6]. Here, the motion field may consist of (or comprise) three components, a spatial displacement of a sample in horizontal direction, a spatial displacement of a sample in vertical direction and a scale component. The latter may signal if an linear interpolation of multiple blurred versions of the reference picture is used. However, the motion field may be defined differently (e.g., with only two components, e.g., only for vertical and horizontal displacement, e.g., with four or more components). For an interpolation of the spatial displacement, a two-dimensional 8-tap Lanczos filter may be used.

The features zᵢ₊₁ are then quantized (e.g., in order to obtain \hat{z}ᵢ₊₁) and transmitted with entropy coding (e.g., entropy encoded, wherein the entropy coded version is transmitted). To improve the transmission, zᵢ₊₁ may also be used as input for a hyperencoder framework to extract hyperparameters (\hat{μ}ₖ, \hat{σ}ₖ) (e.g., arithmetic mean and standard deviation, e.g., quantized versions thereof) for each channel k (e.g., for each colour channel or for more channels). The transmitted features \hat{z}ᵢ₊₁ (e.g., quantized or dequantized remainder latents) may be used as input for the decoder Dec to reconstruct the motion field \hat{f}ᵢ₊₁ (e.g., media-related data) as

\hat{z}ᵢ₊₁=Q(zᵢ₊₁), \hat{f}ᵢ₊₁=Dec(\hat{z}ᵢ₊₁)

where Q indicates the used quantization.

Then, a motion compensated prediction x̅ᵢ₊₁ (e.g., a version of the reference picture \hat{x}ᵢ in which samples or pixels have been relocated by one or more motion vectors) is created by applying the motion field to the coded reference picture \hat{x}ᵢ. Afterwards, a resulting residual rᵢ₊₁=xᵢ₊₁−x̅ᵢ₊₁ may be coded with VTM-14.0 in the All-Intra setting without in-loop filters. The coded picture \hat{x}ᵢ₊₁ can be calculated (derived) as \hat{x}ᵢ₊₁=\hat{r}ᵢ₊₁+x̅ᵢ₊₁. The residual may be also processed as media related data (e.g., with a latent inferencer deriving latents for the current frame and a media data inferencer deriving from said latents media-related data in form of the residual). Therefore, different types of media-related data may be derived for the same current frame 18 (e.g., from two or more different sets of quantized remainder latents).

FIG. 5 shows a schematic view of a system 11 comprising an encoder Enc* (e.g., comprising a remainder inferencer 54) and a decoder Dec* (e.g., comprising a latent inferencer 26). The system 11 may further comprise one or more of an hyperencoder, hyperdecoder and may comprise at least parts of the Encoder Enc and Decoder Dec.

FIG. 5: Overview of the proposed conditional coding framework. Here, the network Enc includes the motion estimation and transformation to the latent space by Enc′ for 4 different block sizes and the merging of the 4 outputs with Enc″ (e.g., wherein Enc′ and Enc″ may be part of Enc) which results in the features zᵢ₊₁. The dotted line indicates that a component is changed for the predictive coding (e.g., compared to a version without a latent inferencer). A red line 74 indicates that the components were added for the predictive coding. This applies, e.g., for the new encoder Enc*, the new decoder Dec* and the transmitted features from the previous frame \hat{z}ᵢ (e.g., latents of a previous frame). The black dotted line indicates that the component was retrained for the conditional coding, this may affect the Hyperencoder and Hyperdecoder.

The sequence for x₁ is shown in FIG. 5 if the components with the dashed line are omitted and both \hat{z}*ᵢ₊₁ and z*ᵢ₊₁ are equal to their counterparts \hat{z}ᵢ₊₁ and zᵢ₊₁ (e.g., without the use of Enc* and Dec*). The used exemplary parameters for each layer are shown in Table I (from [15]).

### 4.III. Conditional and Predictive Coding of the Motion Information

For the first P frame x₁ (e.g., frame index i=1), the same framework as in Section 4.II may be used (e.g., without using Enc*, Dec*, Hyperencoder, and Hyperdecoder in FIG. 5). In the frames x₂, . . . , xₙ (e.g., frame index i=2 . . . n), the predictive feature coding module may be employed (e.g., using Enc* and Dec* in FIG. 5). Therefore, an additional en- and decoder and the hyperencoder and hyperdecoder may be (re-)trained (and/or provided). First, the same steps as in Section 4.II are performed to create the initial features zᵢ₊₁ (e.g., comprising information representative of a motion field). Then, instead of quantizing and transmitting zᵢ₊₁ (e.g., features defined by latents), they are used together with the transmitted information from the previous frame \hat{x}ᵢ (e.g., quantized or dequantized version of transmitted information). The current features zᵢ₊₁ and the previous features \hat{z}ᵢ are used as input for the new encoder Enc* (e.g., having a neural network trained to infer latents) to create the new features z*ᵢ₊₁ (e.g., remainder latents 58). Afterwards, these features z*ᵢ₊₁ are quantized (e.g., in order to obtain quantized remainder latents 63) and transmitted as

$${z}_{i + 1}^{*} = Enc * ( {z}_{i + 1} , {\hat{z}}_{i} ) , {\hat{z}}_{i + 1}^{*} = Q ( {z}_{i + 1}^{*} )$$

Since it may be assumed (but not necessarily always the case) that the distribution (e.g., mean μ and/or variance σ) of the features z*ᵢ₊₁ is different to the distribution of the features zᵢ₊₁, a retrained version of the hyperencoder framework may be used to improve the transmission. An entropy decoder (e.g., exemplary comprised by Dec* or arranged before an input of Dec*) may be configured to decode quantized remainder latents \hat{z}*ᵢ₊₁ of a current frame xᵢ₊₁ of a media signal from a data stream. To recreate features that are compatible with the underlying framework (comprising or forming system 11) consisting of (or comprising) Enc and Dec, we apply a decoder Dec* to the transmitted features from both the current and the previous frame to get features \hat{z}ᵢ₊₁.

$${\hat{z}}_{i + 1} = Dec * ( {\hat{z}}_{i + 1}^{*} , {\hat{z}}_{i} )$$

Dec* (or a latent inferencer of Dec*) may be configured to derive latents \hat{z}ᵢ₊₁ of the current frame x₁₊₁ based on quantized remainder latents \hat{z}*ᵢ₊₁ and latents \hat{z}ᵢ of a previous frame \hat{x}ᵢ. Afterwards, these features (e.g., \hat{z}ᵢ₊₁) are used as input for Dec to reconstruct (e.g., derive) a motion field \hat{f}ᵢ₊₁ (or at least a part thereof) as in Section 4.II. For example, a media data inferencer (e.g., formed or comprised by decoder Dec) may be configured to derive from the latents \hat{z}ᵢ₊₁ of the of the current frame xᵢ₊₁ media-related data (e.g., motion vectors or motion vector field \hat{f}ᵢ₊₁) concerning the current frame.

In the underlying Enc and Dec framework, the parameters may be chosen as before (e.g., as described above in chapter 4.II). For each of the new networks Enc* and Dec*, for example, two convolutional layers with kernel size 3×3 (or any other size, 4×4, 5×5 or larger) and one ReLu activation function (or any other activation function) after the first layer may be used. Assume, for example, that ch_{z} equals a channel size of the features zᵢ₊₁. To fit into the existing framework, the output channel size of a second layer may be reduced to ch_{z} from 2·ch_{z} in the first layer (e.g., from a channel size of 256 to 128).

Another approach to use the existing information in the latent space may be predictive coding with a single network as in [13]. Here, a network pred may be trained to predict the current features from the previous features. This prediction can then be used to create a residual, which is quantized and transmitted as

$${z}_{i + 1}^{*} = {z}_{i + 1} - pred ( {\hat{z}}_{i} ) , {\hat{z}}_{i + 1}^{*} = Q ( {z}_{i + 1}^{*} ) .$$

For example, a media-to-latents encoder (e.g., of the network pred or a separate network, e.g., media-to-latents encoder 50 of FIG. 3) may be configured to derive from a current frame xᵢ₊₁ interim latents zᵢ₊₁ and a remainder inferencer (e.g., of the network pred or a separate network, e.g., remainder inferencer 54 of FIG. 3) may be configured to derive remainder latents

$${z}_{i + 1}^{*}$$

based on the interim latents zᵢ₊₁ and latents \hat{z}ᵢ of a previous frame (e.g., pred(\hat{z}ᵢ)). A further latent inferencer (e.g., of the network pred or a separate network, e.g., further latent inferencer 64 of FIG. 3) may derive latents \hat{z}ᵢ of the previous frame based on quantized remainder latents \hat{z}*ᵢ of the previous frame and latents zᵢ₋₁ of the even more previous frame.

The network pred may form a common neural network (e.g., network 76 in FIG. 3) forming a second neural network of the remainder inferencer and a third neural network of the further latent inferencer. The network pred may be configured to linearly subtract predicted latents pred(\hat{z}ᵢ) of the current frame xᵢ₊₁ obtained by the common neural network pred from the latents \hat{z}ᵢ of the previous frame from the interim latents zᵢ₊₁ of the current frame to obtain the remainder latents

$${z}_{i + 1}^{*}$$

of the current frame, and an adder (e.g., adder 80 in FIG. 3) may be configured to linearly add predicted latents pred(\hat{z}ᵢ₋₁), of the previous frame obtained by the common neural network pred from the latents of the even more previous frame on the one hand and the quantized remainder latents \hat{z}*ᵢ of the previous frame on the other hand to obtain the latents of the previous frame.

A latent quantizer (e.g., of the network pred or a separate network) may quantize the remainder latents

$${z}_{i + 1}^{*}$$

in order to obtain quantized remainder latents \hat{z}*ᵢ₊₁. At the decoder side, the prediction may be added to the transmitted residual to create the transmitted current features as

$${\hat{z}}_{i + 1} = {\hat{z}}_{i + 1}^{*} + pred ( {\hat{z}}_{i} )$$

A latent inferencer at the decoder side (e.g., latent inferencer 26 of FIG. 1) may comprise a first neural network and may be configured to derive latents \hat{z}ᵢ₊₁ of the current frame xᵢ₊₁ based on the quantized remainder latents \hat{z}*ᵢ₊₁ of the current frame and latents \hat{z}ᵢ of a previous frame \hat{x}ᵢ using the first neural network.

The latent inferencer may comprise the first neural network (e.g., first neural network 34 in FIG. 1) and an adder (e.g., adder 36 in FIG. 1), wherein the first neural network may be configured to derive, by way of a non-linear mapping, from the latents 2; of the previous frame predicted latents pred(\hat{z}ᵢ) of the current frame, and the adder may be configured to linearly add the predicted latents pred(\hat{z}ᵢ) of the current frame and the quantized remainder latents \hat{z}*ᵢ₊₁ of the current frame to obtain the latents \hat{z}ᵢ₊₁ of the current frame.

Note, that such a framework may be a more restricted version of the previously presented predictive feature coding scheme. Given, that an activation function may be used which can be different per channel, the version with the network pred equals the version with Enc*, Dec* with some parts of the weight matrix set to the identity matrix or zero matrix.

The network architecture of pred may be similar to the networks Enc* and Dec*. Again, for example, two convolutional layers with the same kernel size (e.g., 3×3 or any other size) and activation function (e.g., ReLu or any other activation function) may be used. However, both the input channel size (e.g., 256) and the output channel size (e.g., 128) for both layers equal ch_{z} as shown in Table II. However, any other size for the input channel and the output channel may be used.

TABLE II
Overview of an example of the network architecture for the
conditional feature coding (Enc* and Dec*) and the predictive
feature coding(pred). All networks may use, for example, 2
layers with a kernel size of 3 × 3, stride 1 without
any up- or downsampling and the output channel size as denoted
by the first number of the entry (e.g., 256 or 128). After
the first layer a Relu activation function may be used.

| Encoder Enc* | Decoder Dec* | pred |
|---|---|---|
| 256 × 3 × 3, s 1 | 256 × 3 × 3, s 1 | 128 × 3 × 3, s 1 |
| ReLu | ReLu | ReLu |
| 128 × 3 × 3, s 1 | 128 × 3 × 3, s 1 | 128 × 3 × 3, s 1 |

Note, that the new conditional feature coding module may effectively only replace the quantization and transmission with a new variational autoencoder. In theory, such a module could be applied to an arbitrary framework.

The advantage of such a module is that existing dependencies between consecutive frames can be leveraged. Especially motions such as camera panning or moving objects can be predicted with such a framework. In contrast to classical optical flow tasks, there is less interest in predicting the transmitted motion field itself. Instead, there is interest in improving the transmission of the compressed information in the latent space which can be achieved by using the existing information in this domain.

### 4.IV. Training Details

In the following details for an exemplary training will be described. It is noted that the training is not limited thereto and can be carried out with different parameters.

The underlying model for the first P frame was trained as in [15]. The conditional feature coding module was trained similarly. As before, the quantization is replaced by adding uniform noise

$$ϵ \sim U ( \frac{- 1}{2} Δ , \frac{1}{2} Δ ) .$$

The training dataset is the BVI-DVC dataset [16] in class C with a resolution of 960×544, cropped to 256×256 patches. In the training, the Adam optimizer [17] with a decaying learning rate of 10⁻⁴*1.13-j with j=0, . . . , 19 was used.

The Enc*, Dec* model from Section 4.Ill was trained similarly to the model in [15]. It also tries to minimize sum of the rate of the motion field R_{mf} and the estimated rate of the residual Rᵣₑₛ but has an additional weighting term as

Rₜₒₜₐₗ=R_{mf}+Rᵣₑₛ+w·(zᵢ₊₁−\hat{z}ᵢ₊₁)², (1)

Rᵣₑₛ≈κΣ_{B}_{_{j∥DCT(}}xᵢ₊₁| [symbol] ⱼ−x̅ᵢ₊₁| [symbol] ⱼ)∥₁, (2)

R_{mf}≈Σₖ−log₂P_{z}(\tilde{z}ₖ, (\hat{μ}ₖ,\hat{σ}ₖ))+Σₗ−log₂P_{y}(\tilde{y}ₗ,φ) (3)

with weight w, regularization parameter κ, sets of partition blocks Bⱼ, and parameters φ of a probability density function. Here, the estimated rate of motion field consists of the cross entropy of the features with added noise \tilde{z} and the hyperpriors (e.g., wherein one or more of the hyperparameters \hat{μ}ₖ, \hat{σ}ₖ may be determined based on one or more of the hyperpriors \hat{μ}ₖ, \hat{σ}ₖ) with added noise \tilde{y} where k and l symbolize all corresponding spatial and channel positions.

To estimate the cost of coding the residual with a blockbased transform coder, in the original picture and the motion compensated prediction is partitioned into 16×16 (or any other sized) blocks as indicated by { [symbol] ⱼ}_{j∈J} and a separable DCT-II transform (discrete cosine transform) is applied to their difference for each block. Then, a l1-norm (e.g., Taxicab norm, e.g., sum of absolute values) of the transformed blocks is summed up.

Additionally, a weighted sum of squared errors of the input features zᵢ₊₁ and output features \hat{z}ᵢ₊₁ may be added to ensure that the underlying model receives a similar input for the decoder Dec as before. This model is trained with six consecutive frames as it improved the performance of the model.

Note that in case that this module is applied to a fully end-to-end trained deep video compression framework, Equation 2 can instead use the estimated bitrate of residual based on the cross entropies of the residual features (and if applicable the residual hyperpriors).

For the single network pred as described in Section III, the training process is much simpler. For the residual between the original features and the predicted features, a smaller residual corresponds to a better prediction of our network pred. Thereby, it is sufficient to minimize the rate of the residual. Moreover, the training could be limited to 4 consecutive frames.

### 4.V. Experiments

The models were tested with the JVET CTC test sequences [18] in classes B, C and D over 16 frames in an IPPP setting. VTM-14.0 [14] was used in the All-Intra setting without inloop
filters to code the I-frame and the residual. The model described herein is compared to [15] in their best setting, which corresponds to the present model in the first P-frame without any conditional or predictive feature coding. The improvement is measured as the Bjontegaard-Delta rate (BD rate) [19] over 4 operation points for QPs 22, 27, 32 and 37 with an I-frame offset of −1 and an P-frame offset of 5.

For each model, a rate distortion optimization was used. When evaluating the model Enc*, Dec*, the features

$${z}_{i + 1}^{*}$$

were optimized with respect to R_{mf}+Rᵣₑₛ. For the model pred, the features zᵢ₊₁ were optimized.

TABLE III
BD-rate savings of the model described
herein compared to the model from [15]

| sequence | Enc*, Dec* | pred |
|---|---|---|
| BasketballDrive | −9.27% | −6.30% |
| BQTerrace | −3.61% | −1.41% |
| Cactus | −3.86% | −2.89% |
| MarketPlace | −2.48% | −4.56% |
| RitualDance | −4.89% | −4.83% |
| class B | −4.82% | −4.00% |
| BasketballDrill | −3.49% | −2.03% |
| BQMall | −2.26% | −3.98% |
| PartyScene | −0.94% | −1.66% |
| RaceHorses | −3.19% | −1.56% |
| class C | −2.47% | −2.31% |
| BasketballPass | −1.73% | −3.67% |
| BlowingBubbles | −0.39% | −3.99% |
| BQSquare | −0.39% | −2.42% |
| RaceHorses | −4.05% | −3.37% |
| class D | −1.64% | −3.36% |

As shown in Table III, both models result in improvements for all sequences in all tested classes. For the model Enc*, Dec* with two networks, the highest gain could be achieved for class B with −4.82% with the single highest improvement for the sequence “BasketballDrive” with BD rate savings of −9.27%. The model pred could achieve an average gain of −4% for class B where the same single sequence could achieve BD rate savings of −6.30%.

For class C, the Enc*, Dec* model could achieve higher gains with −2.47% on average compared to −2.31% for the pred model while for class D the pred model could achieve gains of −3.36% on average compared to −1.64%. For all classes neither of the models could outperform the other as for single sequences the overall better model was worse, e.g “MarketPlace” in class B, “BQMall” in class C and “RaceHorses” in class D. Sequences with fast camera panning such as “BasketballDrive” or fast moving objects as in “RaceHorses” and “BasketballDrill” seem to be coded more efficiently with the generalized model Enc*, Dec*.

### 4.VI. Conclusion

This disclosure shows that the implementation of a conditional feature coding module on top of existing deep learned motion compensation frameworks improves the performance on all tested sequences by up to 9%. Additionally, both variants of the module use a straightforward training process and only add simple CNNs to the existing architecture.

### FURTHER EMBODIMENTS

In the above sections, specific embodiments have been described. In the following, further embodiments are described which are based on the above thoughts and ideas, but are broadened. In particular, these further embodiments are described by way of the following figure. Modifications are feasible compared to the structure shown in this figure which are derivable from the description brought forward below and the claims which follow then.

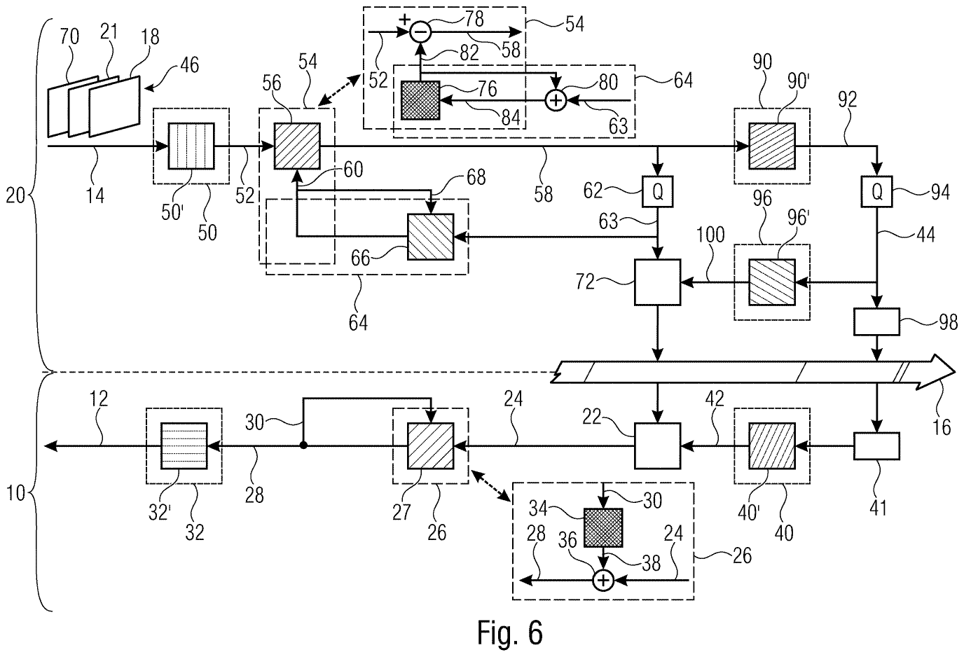

FIG. 6 shows a schematic view of a variational autoencoder 20 (e.g., variational media autoencoder 20) and a decoder 10 (e.g. media decoder 10). Further optional functions of the variational autoencoder 20 and/or the media decoder 10 will be described with reference to FIG. 6. It is noted that multiple optional features will be described with reference to FIG. 6 for the sake of the conciseness and optional synergetic effects, but the optional features may be used in isolation or in any combination unless stated otherwise.

In FIG. 6, a media decoder 10 for decoding media-related data 12 concerning a media signal from a data stream 16 is shown. Although the media signal is illustrated as being a video 46, the media signal may alternatively by a multi-view video signal, an audio signal or a multi-channel audio signal.

Further, the media-related data 12 concerning the media signal is, in the above described sections (e.g., with reference to FIG. 5), a representation of a change of the media signal between the current frame (e.g., original picture xᵢ₊₁) and the previous frame (e.g., \hat{x}ₜ), namely a motion field (e.g., \hat{f}ᵢ₊₁) between a current frame and a previous frame, with the decoder (e.g., Dec*) being, for instance, a video's motion field decoder and the encoder (e.g., Enc*) shown being a video's motion field encoder, but it could also be that same is a representation of the media signal at the current frame, e.g. a picture or an audio frame, so that the decoder was, for instance, a video decoder, or an audio decoder and the encoder correspondingly a video encoder or audio encoder.

The data stream 16 received and decoded by the decoder 10 is one having been encoded by a variational autoencoder 20, which is described later. The media decoder 10 comprises an entropy decoder 22 (e.g., an arithmetic decoder) configured to decode quantized remainder latents 24 of a current frame 18 (e.g., original picture xᵢ₊₁ in FIG. 5) of the media signal from the data stream 16. To this end, the decoder 10 may comprise a hyperdecoder 40 comprising a third neural network 40′ and configured to derive statistical entropy-coding parameters 42 (e.g., related to or in form of mean values and/or standard deviation, e.g., for each channel) from a quantized hyperprior 44 in the data stream 16 (e.g., decoded using a hyperprior decoder 41) using the third neural network 40′. The entropy decoder 22 decodes the quantized remainder latents 24 of the current frame of the media signal from the data stream 16 using the statistical entropy-coding parameters 42. Thus, PDFs (e.g., probability density functions) for coding the quantized remainder latents 24 are latent-individually (or provided for sets of latents) provided by the hypredecoder 40 based on the quantized hyperprior. The hyperdecoder along with the hyperencoder in the encoder 20, forms a hypercoding system which uses for encoding/decoding the quantized hyperprior a PDF which is, for instance, trained along with the training of the hypercoding system.

A latent inferencer 26 comprising a first neural network 27; 34 derives latents 28 of the current frame 18 based on the quantized remainder latents 24 of the current frame 18 and latents 30 of a previous frame 21 using the first neural network. The latents 30 of a previous frame 21, in turn, are derived by use of quantized remainder latents of an even more previous, even earlier frame. This reduces, as described above, any otherwise remaining redundancies in the latent domain.

A media data inferencer 32 comprising a second neural network 32′ derives from the latents 28 of the current frame the media-related data 12 concerning the current frame 18 using the second neural network 32′.

FIG. 6 shows that there alternatives with respect to the structure of the latent inferencer 26. According to a first variant which is primarily shown in FIG. 6, the first neural network 27 forms all functionalities of the latent inferences 26 and non-linearly and/or in a manner not separable combines all inputs of the latent inferencer 26. That is, the first neural network 27 receive as inputs, and combines in a manner non-linearly with respect to, and in a manner non-separable (e.g., wherein based on an output and one of the inputs, the other output cannot be determined, at least not trivially, e.g., due to a combination of the input through multiple non-trivial layers of the neural network, e.g., wherein the combination uses one or more of fully connected layer, a non-trivial partially connected layer, and a convolutional layer) with respect to the quantized remainder latents 24 of the current frame 18 on the one hand and the latents 30 of the previous frame 21 on the other hand, the quantized remainder latents 24 of the current frame and latents 30 of the previous frame to obtain the latents 28 of the current frame. In different words, the first neural network 27 has at least one neuron whose inputs comprise at least one input which depends on the quantized remainder latents 24 of the current frame and at least one further input which depends on the latents 30 of the previous frame, wherein the at least one neuron forms a non-linear scalar function applied to a weighted sum of said inputs.

For example, a first set of input nodes of the first neural network 27 may receive the quantized remainder latents 24 (e.g., tensor values thereof) and a second set of input nodes (e.g., different from the first set) may receive the quantized remainder latents 24 and both inputs may be combined in various combinations (e.g., one or more of summing up, weighting, subject to an activation function such as the ReLu function) in one or more layers (e.g., comprising one or more convolutional layers), wherein an output of the first neural network is the latents 24 of the current frame 18. For example, a weighted or non-weighted sum may be formed based on a first subset of the first set of input nodes and a second subset of the second set of input nodes and a ReLu function may be applied to the sum. One or more convolutional layers may be provided, wherein a kernel (e.g., with a size of 3×3 or any other size) is scanned across the input nodes (or nodes of one or more other layers), wherein the kernel determines a new value for the next node, optionally with the use of any activation function disclosed herein. When a kernel is used, no padding may be performed (which may result in a tensor with less entries) or padding may be used (e.g., in order to obtain a tensor with the same number of entries). The latent inferencer 26 may perform further processing steps (after or before the first neural network 27) in order to obtain the latents 24 of the current frame 18.

However, according to an alternative illustrated in the figure as being applicable (depicted as a cut-out in dashed lines), the latent inferencer 26 comprises in addition to the first neural network 34 an adder 36, wherein the first neural network 34 is configured to derive, by way of a non-linear mapping, from the latents 30 of the previous frame predicted latents 38 of the current frame, wherein the adder 36 linearly adds the predicted latents 38 of the current frame and the quantized remainder latents 24 of the current frame to obtain the latents 28 of the current frame.

For example, the first neural network 34 may comprise multiple layers (e.g., comprising one or more convolutional layers), which allow predicting or inferring the predicted latents 38. The predicted latents 38 may have the same number of dimensions and/or numbers of entries (e.g., mapping a three dimensional tensor having 128×128×3 entries onto a new three dimensional tensor having 128×128×3 entries). Alternatively, dimensions and/or entries may differ. The decoder 10 and the variational autoencoder 20 may comprise the same (or similar) networks, so as to allow predicting or inferring the same (or similar) predicted latents 38. The adder 36 may perform an entry wise addition (which may optionally comprise weights, e.g., in form of a weighting tensor) between entries or values of a tensor of the predicted latents 38 and the quantized remainder latents 24. To this end, the predicted latents 38 and the quantized remainder latents 24 may define tensors with the same amount of dimensions and/or same amount of entries. However, different tensors may be used, for example, with a pre-defined rule of which entries to be summed up. Furthermore, the transmitted (or even decoded) quantized remainder latents 24 may have less entries than the entire quantized remainder latents 24 have, wherein zero value entries may be implied to be filled or (or padded). For example, the last five entries of the quantized remainder latents 24 may be zero, but not transmitted for the sake of coding efficiency, wherein the entropy decoder 22 and/or the latent inferencer 26 is configured to derive the missing entries (e.g., due to an expected amount of entries of the tensor) or configured to perform the addition with an incomplete tensor (e.g., not performing a summation for entries that are not received, because they are zero).

The predicted latents 38 may form a prediction of latents that, when mapped to an image space, may form an approximation of the current frame. The predicted latents 38 may therefore form a prediction (e.g., inter-prediction) performed in the latent space. The quantized remainder latents 24 may form a correction that improves or corrects the prediction, wherein the correction may be performed in the latent space and therefore in an information dense (or energy dense) space. However, other type of media may be predicted as well, such as an audio signal, a depth map, a motion vector field, or any other media type described herein.

As said, the media-related data 12 concerning the media signal is, in the above described sections, a motion field between a current frame 18 and a previous frame 21. In this case, data 12 may, for instance, comprise a channel which sample-wise indicates a x coordinate of the motion vectors of the motion field, a further channel which sample-wise indicates a y coordinate of the motion vectors of the motion field, and optionally a channel which indicates sample-wise a reliability of the motion vector at the respective sample positions.

Although shown together in one figure and trained together, decoder 10 and encoder 20 are separate entities most likely communicating with each other across a network at distanced entites such as computer, mobile phones or the like.

The variational media autoencoder 20 for encoding the media-related data 12 concerning the media signal into the data stream 16 comprises a media-to-latents encoder 50 comprising a first neural network 50′ which derives from the current frame 18 of the media signal 14 to be encoded interim latents 52 of the current frame. Again, the media-related data 12 concerning the media signal is, in the above described sections, a motion field between a current frame 18 and a previous frame 21. In this case, the media-to-latents encoder 50 may, for use in encoding the motion field between pictures (or frames) 18 and 21, although not shown in the figure, use the previous picture 21. It may use a reconstructible version of the previous picture 21 which is also derivable by at the decoder side from the data stream (which may or may not differ from an original version of the previous frame 21 before encoding). For example, the encoder 20 may comprise a copy of the media data inferencer 32 (e.g., in regards to obtaining the same output for the same input) which derives from latents 60 of the previous frame 21 the motion field leading from an even more previous frame 70 to the previous frame 21, and may apply this motion field to a version of the even more previous frame 70 which his coded into the data stream as a sort of I frame (correspondingly decoded at decoder 10 side) or itself by means of a motion field. Additionally, and although not shown in the figure, encoder 20 and decoder 10 may comprise a frame residual encoder and a frame residual decoder, respectively, so as to encode into, and decode from, the data stream 12 a residual signal for each picture for which a motion field is coded into the data stream, such as the previous picture 20, and, thus, the media-to-latents encoder 50 may use this residual signal along with the motion field of the previous frame to recover a reconstructible version of the previous frame to, along with the current frame 18, derive the motion field latents 52. As said, however, alternatively, media-to-latents encoder 50 uses the original version of the previous picture along with the original version of the current picture in order to derive therefrom the motion field for the current frame.

Thus, briefly interrupting the description of the encoder 20, decoder 10 and encoder 20 shown in FIG. 6 might be extended to result into decoder/encoder where the media-related data 12 relates to video en/decoding, wherein encoder and decoder comprise, for instance, an additional encoder/decoder for encoding/decoding to/from data stream 16 an I picture, i.e. encoded without motion correction, and, optionally, en/decoding motion-compensation residual pictures which are combined with predicted pictures derived by applying the motion field of a certain picture to its reconstructed predecessor (previous) picture and combining the resulting predicted picture for that certain picture with its motion-compensation residual picture.

A remainder inferencer 54 comprising a second neural network 56; 76 derives remainder latents 58 of the current frame based on the interim latents 52 of the current frame and latents 60 of a previous frame using the second neural network 56; 76. Again, there are two possible implementation variants depicted in the figure. Note that in FIG. 6, blocks showing in neural networks are drawn in a shaded manner (e.g., neural networks 50′, 56, 66, 76, 90′, 96′, 40′, 27, 34, and 32′), and, in particular, blocks shown in equal shading (e.g., neural networks 27 and 66, 40′ and 96′, 34 and 76) correspond to each other in that they are equal to each other.

A latent quantizer 62 quantizes the remainder latents 58 to obtain quantized remainder latents 63 of the current frame. Any quantization scheme might be used (e.g., dependent quantization).

A further latent inferencer 64 comprising a third neural network 66; 76 derives the latents 60 of the previous frame (which may correspond to the latents 30 of a previous frame 21 derivable by the media decoder 10) based on the quantized remainder latents 63 of the previous frame and latents 68 of an even more previous frame 70 using the third neural network 66; 76.

An entropy encoder 72 (e.g., an arithmetic encoder) encodes the quantized remainder latents 63 of the current frame into the data stream 16. To this end, the encoder 20 may comprise a hyperencoder 90 comprising a fourth neural network 90′ which derives a representation 92 of statistical entropy-coding parameters from the remainder latents 58 using the fourth neural network 90′. A hyper quantizer 94 quantizes the representation 92 to obtain a quantized hyperprior 44. A hyperdecoder 96 comprising a fifth neural network 96′ derives the statistical entropy-coding parameters 100 from the quantized hyperprior 44 using the fourth neural network 96′. As seen, same is equal to its pendant in the decoder 10 (e.g., statistical entropy-coding parameters 42 derived from the quantized hyperprior 44 by the hyperdecoder 40). A hyperprior coder 98 encodes the hyperprior into the data stream 16. As indiacted above, hyperencoder and hyperdecoder have been trained accordingly, to use a suitable PDF for the coding of the quantized hyperprior. The entropy encoder 72 encodes the quantized remainder latents 63 of the current frame of the media signal into the data stream 16 using the statistical entropy-coding parameters 100.

FIG. 6 shows that there alternatives with respect to the structure of the latent inferencer 54 (or its respective neural network 56 or 76) and the further latent inferencer 64 (or its respective neural network 66 or 76). According to a first variant which is primarily shown in FIG. 6, the second neural network 56 may be configured to receive as inputs, and combine in a manner non-linearly with respect to, and in a manner non-separable with respect to the interim latents 52 of the current frame on the one hand and the latents 60 of the previous frame on the other hand, the interim latents 52 of the current frame and the latents 60 of the previous frame to obtain the remainder latents 58 of the current frame, and the third neural network 66 is configured to receive as inputs, and combine in a manner non-linearly with respect to, and in a manner non-separable with respect to the quantized remainder latents 63 of the previous frame on the one hand and the latents 68 of the even more previous frame on the other hand, the quantized remainder latents 63 of the previous frame and the latents 68 of the even more previous frame to obtain the latents 60 of the previous frame (e.g., such that the combination thusly obtained corresponds to a combination obtainable by the decoder, e.g., obtainable by the decoder based on received quantized remainder latents 63).

The second neural network 56 may have at least one neuron whose inputs comprise at least one input which depends on the interim latents 52 of the current frame and at least one further input which depends on the latents 60 of the previous frame, wherein the at least one neuron of the second neural network 56 forms a non-linear scalar function applied to a weighted sum of said inputs, and the third neural network 66 has at least one neuron whose inputs comprise at least one input which depends on the quantized remainder latents 63 of the previous frame and at least one further input which depends on the latents 68 of the even more previous frame, wherein the at least one neuron of the third neural network 66 forms a non-linear scalar function applied to a weighted sum of said inputs.

However, according to an alternative illustrated in the figure as being applicable (depicted as a cut-out in dashed lines), the remainder inferencer 54 comprises the second neural network and a subtractor 78 and the further latent inferencer 64 comprises the third neural network and an adder 80, wherein the second and the third neural networks are formed by a common neural network 76 which is configured to derive, by way of a non-linear mapping, predicted latents 82 of a frame based on latents 84 of a reference frame, the subtractor 78 is configured to linearly subtract (e.g., feature wise, e.g., entry-wise) predicted latents 82 of the current frame obtained by the common neural network 76 from the latents of the previous frame from the interim latents 52 of the current frame to obtain the remainder latents 58 of the current frame, and the adder 80 is configured to linearly add predicted latents of the previous frame obtained by the common neural network 76 from the latents of the even more previous frame on the one hand and the quantized remainder latents 63 of the previous frame on the other hand to obtain the latents of the previous frame.

The variational media autoencoder 20 may be a video's motion field encoder, a video encoder, or an audio encoder.

In the following, further implementation alternatives are described, referring to all of the embodiments described above.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In particular, it is noted that FIGS. 2, 5, and 6 may also be regarded as illustration of a method for decoding a video and FIGS. 4, 5, and 6 may be regarded as illustration of a method for encoding a video, where the blocks, modules and stages may be regarded as steps of methods.

Some or all of the method steps may be executed by (or using) a hardware apparatus, like for example, a microprocessor, a programmable computer or an electronic circuit. In some embodiments, one or more of the most important method steps may be executed by such an apparatus.

The inventive encoded image signal can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

Additional embodiments include a method for encoding media-related data concerning a media signal into a data stream, the method comprising: deriving from a current frame of a media signal to be encoded interim latents of the current frame using a first neural network, deriving remainder latents of the current frame based on the interim latents of the current frame and latents of a previous frame using a second neural network, and quantizing the remainder latents to acquire quantized remainder latents of the current frame, deriving the latents of the previous frame based on the quantized remainder latents of the previous frame and latents of an even more previous frame using a third neural network, and encoding the quantized remainder latents of the current frame into the data stream. As well, a data stream may be implemented using this method.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] “Advanced Video Coding for Generic Audio-Visual Services,” ITU-T Rec. H.264 and ISO/IEC 14496-10, 2003.
[2] “High Efficiency Video Coding,” ITU-T Rec. H.265 and ISO/IEC 23008-2, 2013.
[3] “Versatile Video Coding,” ITU-T Rec. H.266 and ISO/IEC 23090-3, 2020.
[4] W.-J. Chien, L. Zhang, M. Winken, X. Li, R.-L. Liao, H. Gao, C.-W. Hsu, H. Liu, and C.-C. Chen, “Motion vector coding and block merging in the versatile video coding standard,” IEEE Transactions on Circuits and Systems for Video Technology, vol. 31, no. 10, pp. 3848-3861, 2021.
[5] G. Lu, W. Ouyang, D. Xu, X. Zhang, C. Cai, and Z. Gao, “DVC: An end-to-end deep video compression framework,” in Proceedings of the IEEE/CVF Conference on Computer Vision and Pattern Recognition, 2019, pp. 11 006-11 015.
[6] E. Agustsson, D. Minnen, N. Johnston, J. Balle, S. J. Hwang, and G. Toderici, “Scale-space flow for end-to-end optimized video compression,” in Proceedings of the IEEE/CVF Conference on Computer Vision and Pattern Recognition, 2020, pp. 8503-8512.
[7] T. Ladune, P. Philippe, W. Hamidouche, L. Zhang, and O. D'eforges, “Optical flow and mode selection for learning-based video coding,” in 2020 IEEE 22nd International Workshop on Multimedia Signal Processing (MMSP). IEEE, 2020, pp. 1-6.
[8] J. Lin, D. Liu, H. Li, and F. Wu, “M-Ivc: Multiple frames prediction for learned video compression,” in Proceedings of the IEEE/CVF Conference on Computer Vision and Pattern Recognition, 2020, pp. 3546-3554.
[9] O. Rippel, S. Nair, C. Lew, S. Branson, A. Anderson, and L. Bourdev, “Learned video compression,” in Proceedings of the IEEE/CVF International Conference on Computer Vision, 2019, pp. 3454-3463.
[10] A. Golinski, R. Pourreza, Y. Yang, G. Sautiere, and T. S. Cohen, “Feedback recurrent autoencoder for video compression,” in Proceedings of the Asian Conference on Computer Vision, 2020.
[11] Z. Hu, G. Lu, and D. Xu, “Fvc: A new framework towards deep video compression in feature space,” in Proceedings of the IEEE/CVF Conference on Computer Vision and Pattern Recognition, 2021, pp. 1502-1511.
[12] K. Lin, C. Jia, X. Zhang, S. Wang, S. Ma, and W. Gao, “Dmvc: Decomposed motion modeling for learned video compression,” IEEE Transactions on Circuits and Systems for Video Technology, 2022. B. Liu, Y. Chen, S. Liu, and H.-S. Kim, “Deep learning in latent space for video prediction and compression,” in Proceedings of the IEEE/CVF conference on computer vision and pattern recognition, 2021, pp. 701-710.
[14] A. Browne, J. Chen, Y. Ye, and S. Kim, “Algorithm description for Versatile Video Coding and Test Model 14 (VTM 14),” JVET-W2002, Joint Video Experts Team (JVET), July 2021.
[15] S. Pientka, M. Schäfer, J. Pfaff, H. Schwarz, D. Marpe, and T. Wiegand, “Block-based motion estimation for deep-learned video coding,” in 2023 IEEE International Conference on Image Processing (ICIP). IEEE, 2023, pp. 3444-3448.
[16] D. Ma, F. Zhang, and D. Bull, “BVI-DVC: A training database for deep video compression,” IEEE Transactions on Multimedia, 2021.
[17] D. P. Kingma and J. Ba, “Adam: A Method for Stochastic Optimization,” in ICLR 2015, Conference Track Proceedings, Y. Bengio and Y. LeCun, Eds., 2015. [Online]. Available: http://arxiv.org/abs/1412.6980
[18] J. Boyce, K. Suehring, X. Li, and V. Seregin, “Jvet common test conditions and software reference configurations,” Document JVETJ1010, 2018.
[19] G. Bjontegaard, “Calculation of average psnr differences between rdcurves,” VCEG-M33, 2001.

1. A media decoder for decoding media-related data concerning a media signal from a data stream having been encoded by a variational autoencoder, the media decoder comprising
an entropy decoder configured to decode quantized remainder latents of a current frame of the media signal from the data stream,
a latent inferencer comprising a first neural network and configured to derive latents of the current frame based on the quantized remainder latents of the current frame and latents of a previous frame using the first neural network, and
a media data inferencer comprising a second neural network and configured to derive from the latents of the current frame the media-related data concerning the current frame using the second neural network.

2. The media decoder according to claim 1, wherein the first neural network is configured to receive as inputs, and combine in a manner non-linearly with respect to, and in a manner non-separable with respect to the quantized remainder latents of the current frame on the one hand and the latents of the previous frame on the other hand, the quantized remainder latents of the current frame and latents of the previous frame to acquire the latents of the current frame.

3. The media decoder according to claim 1, wherein the first neural network comprises at least one neuron whose inputs comprise at least one input which depends on the quantized remainder latents of the current frame and at least one further input which depends on the latents of the previous frame, wherein the at least one neuron forms a non-linear scalar function applied to a weighted sum of said inputs.

4. The media decoder according to claim 1, wherein the latent inferencer comprises the first neural network and an adder, wherein the first neural network is configured to derive, by way of a non-linear mapping, from the latents of the previous frame predicted latents of the current frame, and the adder is configured to linearly add the predicted latents of the current frame and the quantized remainder latents of the current frame to acquire the latents of the current frame.

5. The media decoder according to claim 1, comprising
a hyperdecoder comprising a third neural network and configured to derive statistical entropy-coding parameters from a quantized hyperprior in the data stream using the third neural network,
wherein the entropy decoder is configured to decode the quantized remainder latents of the current frame of the media signal from the data stream using the statistical entropy-coding parameters.

6. The media decoder according to claim 1, wherein the entropy decoder is an arithmetic decoder.

7. The media decoder according to claim 1, wherein the media signal is a video, a multi-view video signal, an audio signal or a multi-channel audio signal.

8. The media decoder according to claim 1, wherein the media-related data concerning the media signal comprises one or more of
a representation of a change of the media signal between the current frame and the previous frame,
a motion field between the current frame and the previous frame,
a representation of the media signal at the current frame, e.g. a picture or an audio frame.

9. The media decoder according to claim 1, wherein the media decoder is
a video's motion field decoder,
a video decoder, or
an audio decoder.

10. A variational media autoencoder for encoding media-related data concerning a media signal into a data stream, comprising
a media-to-latents encoder comprising a first neural network and configured to derive from a current frame of a media signal to be encoded interim latents of the current frame,
a remainder inferencer comprising a second neural network and configured to derive remainder latents of the current frame based on the interim latents of the current frame and latents of a previous frame using the second neural network, and
a latent quantizer configured to quantize the remainder latents to acquire quantized remainder latents of the current frame,
a further latent inferencer comprising a third neural network and configured to derive the latents of the previous frame based on the quantized remainder latents of the previous frame and latents of an even more previous frame using the third neural network, and
an entropy encoder configured to encode the quantized remainder latents of the current frame into the data stream.

11. The variational media autoencoder according to claim 10, wherein
the second neural network is configured to receive as inputs, and combine in a manner non-linearly with respect to, and in a manner non-separable with respect to the interim latents of the current frame on the one hand and the latents of the previous frame on the other hand, the interim latents of the current frame and the latents of the previous frame to acquire the remainder latents of the current frame, and
the third neural network is configured to receive as inputs, and combine in a manner non-linearly with respect to, and in a manner non-separable with respect to the quantized remainder latents of the previous frame on the one hand and the latents of the even more previous frame on the other hand, the quantized remainder latents of the previous frame and the latents of the even more previous frame to acquire the latents of the previous frame.

12. The variational media autoencoder according to claim 10, wherein
the second neural network comprises at least one neuron whose inputs comprise at least one input which depends on the interim latents of the current frame and at least one further input which depends on the latents of the previous frame, wherein the at least one neuron of the second neural network forms a non-linear scalar function applied to a weighted sum of said inputs, and
the third neural network comprises at least one neuron whose inputs comprise at least one input which depends on the quantized remainder latents of the previous frame and at least one further input which depends on the latents of the even more previous frame, wherein the at least one neuron of the third neural network forms a non-linear scalar function applied to a weighted sum of said inputs.

13. The variational media autoencoder according to claim 10, wherein the remainder inferencer comprises the second neural network and a subtractor and the further latent inferencer comprises the third neural network and an adder,
wherein the second and the third neural networks are formed by a common neural network which is configured to derive, by way of a non-linear mapping, predicted latents of a frame based on latents of a reference frame, the subtractor is configured to linearly subtract predicted latents of the current frame acquired by the common neural network from the latents of the previous frame from the interim latents of the current frame to acquire the remainder latents of the current frame, and the adder is configured to linearly add predicted latents of the previous frame acquired by the common neural network from the latents of the even more previous frame on the one hand and the quantized remainder latents of the previous frame on the other hand to acquire the latents of the previous frame.

14. The variational media autoencoder according to claim 10, comprising
a hyperencoder comprising a fourth neural network and configured to derive a representation of statistical entropy-coding parameters from the remainder latents using the fourth neural network,
a hyper quantizer configured to quantize the representation to acquire a quantized hyperprior,
a hyperdecoder comprising a fifth neural network and configured to derive the statistical entropy-coding parameters from the quantized hyperprior using the fourth neural network, and
a hyperprior coder configured to encode the hyperprior into the data stream,
wherein the entropy encoder is configured to encode the quantized remainder latents of the current frame of the media signal into the data stream using the statistical entropy-coding parameters.

15. The variational media autoencoder according to claim 10, wherein the entropy encoder is an arithmetic encoder.

16. The variational media autoencoder according to claim 10, wherein the media signal is a video, a multi-view video signal, an audio signal or a multi-channel audio signal.

17. The variational media autoencoder according to claim 10, wherein the media-related data concerning the media signal comprises one or more of
a representation of a change of the media signal between the current frame and the previous frame,
a motion field between the current frame and the previous frame,
a representation of the media signal at the current frame, e.g. a picture or an audio frame.

18. The variational media autoencoder according to claim 10, being
a video's motion field encoder,
a video encoder, or
an audio encoder.

19. A method for decoding media-related data concerning a media signal from a data stream having been encoded by a variational autoencoder, the method comprising
decoding quantized remainder latents of a current frame of the media signal from the data stream,
deriving latents of the current frame based on the quantized remainder latents of the current frame and latents of a previous frame using a first neural network, and
deriving from the latents of the current frame the media-related data concerning the current frame using a second neural network.

20. A data stream generated using a method for encoding media-related data concerning a media signal into a data stream, the method comprising
deriving from a current frame of a media signal to be encoded interim latents of the current frame using a first neural network,
deriving remainder latents of the current frame based on the interim latents of the current frame and latents of a previous frame using a second neural network, and
quantizing the remainder latents to acquire quantized remainder latents of the current frame,
deriving the latents of the previous frame based on the quantized remainder latents of the previous frame and latents of an even more previous frame using a third neural network, and
encoding the quantized remainder latents of the current frame into the data stream.
